(19) United States
(12) Patent Application Publication
(10) Pub. No.: US 2022/0289172 A1
(43) Pub. Date: Sep. 15, 2022

(54) DRIVING MACHINE

(71) Applicant: HONDA MOTOR CO., LTD., Tokyo (JP)

(72) Inventors: Koji Kuriyagawa, Wako-shi (JP); Tetsuya Kobayashi, Wako-shi (JP)

(73) Assignee: HONDA MOTOR CO., LTD., Tokyo (JP)

(21) Appl. No.: 17/689,446

(22) Filed: Mar. 8, 2022

(30) Foreign Application Priority Data
Mar. 15, 2021 (JP) 2021-041582

(51) Int. Cl. B60W 20/40; B60W 20/20; B60W 50/08

(52) U.S. Cl. CPC B60W 20/40; B60W 20/20; B60W 50/082; B60W 2510/08

(57) ABSTRACT

There is provided with a driving machine capable of easily performing switching from a power saving mode to an engine drivable mode. A driving machine comprises an engine; a battery; an operation unit including an emergency stop switch that stops the engine; and a control unit having operation modes, the operation modes including a normal mode in which the engine is drivable and a power saving mode in which the engine is not drivable and a power consumption amount of the battery is suppressed to be smaller than a power consumption amount of the battery in the normal mode, wherein the control unit switches from the power saving mode to the normal mode based on an input of the emergency stop switch when the operation mode is the power saving mode.

### CROSS-REFERENCE TO RELATED APPLICATION(S)

This application claims priority to and the benefit of Japanese Patent Application No. 2021-041582 filed on Mar. 15, 2021, the entire disclosure of which is incorporated herein by reference.

### BACKGROUND OF THE INVENTION

### Field of the Invention

The present invention relates to a driving machine.

### Description of the Related Art

The driving machine drives a working unit or the like by a mounted engine. The driving machine includes a switch that enables driving of the engine. When a power supply switch is operated to an ON position and a start switch is operated to a start position, a battery voltage is supplied to a starter motor or the like, and the engine is driven. In addition, when the power supply switch is operated to an OFF position during operation of the engine, the engine is stopped.

The driving machine includes a driven mechanism such as a steering mechanism or a shift changing mechanism. Once the power supply switch is operated to the ON position, the battery voltage is supplied to the driven mechanism, and the driven mechanism is configured such that it can be operated even when the engine is stopped. Meanwhile, the driving machine is used in a specific season or time zone, is then stored in a warehouse or the like, and is not used for a relatively long period of time in some cases. Therefore, when the driving machine is housed in a state in which the power supply switch remains at the ON position after the driven mechanism is operated, the battery voltage continues to be supplied to the driven mechanism, and the battery may be down.

Japanese Patent Laid-Open No. 2017-018131 discloses a technology in which power continues to be supplied from a battery to each mechanism even after an engine is stopped, and when a state in which the engine is not started continues for a predetermined time or more after the engine is stopped, switching to a power cutoff state, in which the power from the battery is substantially not supplied to each mechanism, is made.

### SUMMARY OF THE INVENTION

According to one embodiment of the present invention, a driving machine comprises an engine; a battery; an operation unit including an emergency stop switch that stops the engine; and a control unit having operation modes, the operation modes including a normal mode in which the engine is drivable and a power saving mode in which the engine is not drivable and a power consumption amount of the battery is suppressed to be smaller than a power consumption amount of the battery in the normal mode, wherein the control unit switches from the power saving mode to the normal mode based on an input of the emergency stop switch when the operation mode is the power saving mode.

### BRIEF DESCRIPTION OF THE DRAWINGS

FIG. 1 is a schematic view of an outboard machine according to an embodiment;

FIG. 2 is a block diagram of the outboard machine according to the embodiment;

FIG. 3 is a state transition diagram of a control unit according to the embodiment;

FIG. 4 is a flowchart illustrating a control mode of the control unit based on an input operation of a user performed on an operation unit; and

FIG. 5 is a flowchart illustrating the control mode of the control unit based on the input operation of the user performed on the operation unit.

### DESCRIPTION OF THE EMBODIMENTS

When a power supply switch is not operated to an OFF position and enters a power cutoff state (power saving mode), the power supply switch remains at an ON position. Even in a case where a user operates a start switch to a start position for restarting an engine, the engine cannot be started because although the power supply switch is at the ON position, the power is cut off. Therefore, the user operates the power supply switch from the ON position to the OFF position, then operates the power supply switch to the ON position, and operates the start switch to the start position.

An embodiment of the present invention provides a driving machine capable of easily performing switching from a power saving mode to an engine drivable mode.

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The driving machine according to the embodiment includes: an engine; a battery; an operation unit including an emergency stop switch that stops the engine; and a control unit having operation modes, the operation modes including a normal mode in which the engine is drivable and a power saving mode in which the engine is not drivable and a power consumption amount of the battery is suppressed to be smaller than a power consumption amount of the battery in the normal mode, in which the control unit switches from the power saving mode to the normal mode based on an input of the emergency stop switch when the operation mode is the power saving mode, such that it is possible to easily perform switching from the power saving mode to the engine drivable mode. Hereinafter, configurations of the respective components will be described.

(Driving Machine)

The driving machine is equipped with an engine, and is configured to move itself by the engine or to drive another component (working unit) by the engine. The driving machine is not particularly limited, and examples thereof include an outboard machine, an agricultural machine such as a cultivator, a snow blower, a generator, a lawn mower, and the like. Hereinafter, the driving machine will be described by taking the outboard machine as an example.

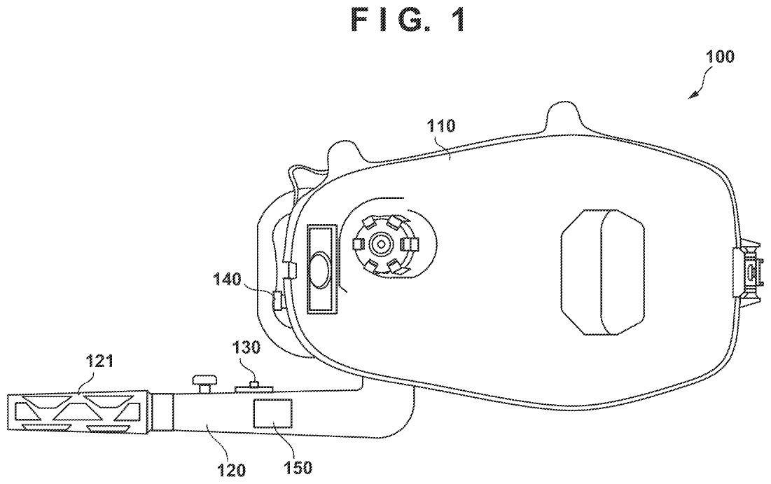

FIG. 1 is a schematic view of the outboard machine according to the embodiment, in which an outboard machine 100 is viewed from above. The outboard machine 100 includes a cover 110, and an engine, a starter motor, a battery, a control unit, and the like are housed (not illustrated) in the cover 110. The engine is supported by a lower case and connected to the working unit, and the working unit includes a shaft provided in a substantially vertical direction (a depth direction in the drawing) and a propeller fixed to the shaft via a gear or the like (not illustrated).

A steering handle 120 extending forward is provided in the lower case. The steering handle 120 includes a rotatably operable throttle grip 121, and when the throttle grip 121 is rotated, an engine speed is changed.

A power supply switch 130 is provided on the steering handle 120. When the user operates the power supply switch 130 from the OFF position to the ON position, the power is supplied from the battery to the control unit. In the outboard machine according to the embodiment, the start switch is provided integrally with the power supply switch 130, and when the power supply switch 130 is operated from the ON position to the start position, the starter motor is driven and the engine is driven. The start switch may be provided separately from the power supply switch 130.

An emergency stop switch 140 is provided on a front side of the lower case. As will be described in detail later, the emergency stop switch 140 has a function of immediately stopping the engine and a function of performing switching from the power saving mode to the normal mode in which the engine is drivable. Depending on the outboard machine 100, due to the function of immediately stopping the engine, the emergency stop switch 140 may be positioned closer to the user operating the outboard machine 100 than the power supply switch 130 is.

A display unit 150 is provided on the steering handle 120. The arrangement of the display unit 150 is not particularly limited, and the display unit 150 is provided at a position where the user can easily check the display unit 150. The display unit 150 can display that the emergency stop switch 140 has the emergency stop function and the operation mode switching function, and the user can recognize that returning from the power saving mode to the normal mode can be made by the emergency stop switch 140. Furthermore, the display unit 150 can also be configured to display various states such as the state of the engine and the state of charge of the battery.

The battery is not particularly limited, and examples thereof include a rechargeable secondary battery such as a lithium ion battery or a nickel hydrogen battery. In an embodiment, the control unit can also charge the battery using power generated by regenerative braking of the engine.

(Control Unit)

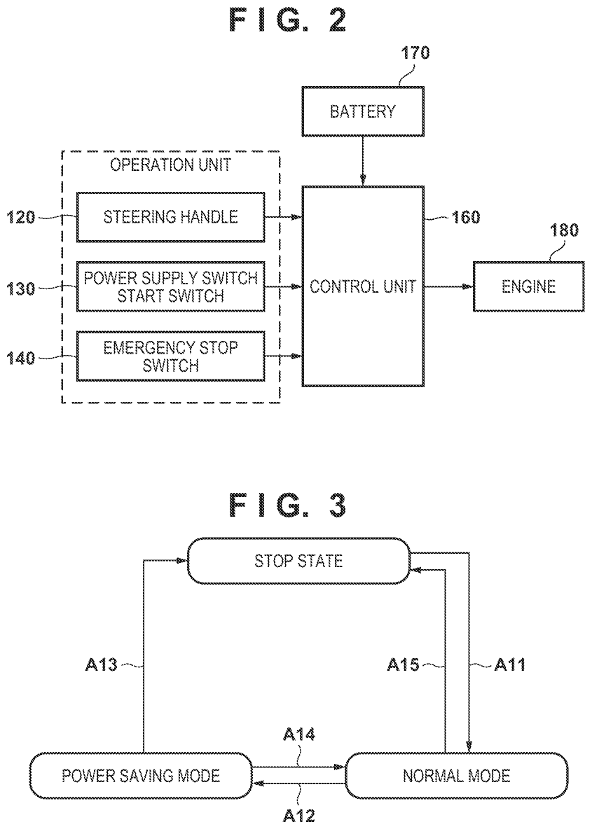

FIG. 2 is a block diagram of the outboard machine according to the embodiment. The outboard machine 100 includes a control unit 160. The control unit (control device) 160 is an electric component that receives electric power from the battery 170 and controls the respective components such as the engine 180, the working unit (not illustrated), and the like based on an input operation of the user performed on the operation unit. The control unit 160 can also include, for example, a wiring portion for implementing electrical connection between elements in addition to one or more mounting substrates on which electronic components are mounted. Examples of the electronic component include semiconductor devices such as an application-specific integrated circuit (ASIC) and a programmable logic device (PLD). Examples of the wiring portion include a wire harness, a flexible printed circuit (FPC), and a chip on film (CoF).

In an embodiment, the control unit 160 includes a signal processing circuit unit, a detection circuit unit, a starting circuit unit, a power supply circuit unit, and the like. The signal processing circuit unit is a micro controller unit (MCU) or a micro processing unit (MPU) that performs signal processing for performing a system control of the entire outboard machine 100. As the detection circuit unit, one or more input circuits IC capable of detecting an operation input to the operation unit such as the steering handle 120, the power supply switch 130, the start switch, or the emergency stop switch 140 can be used. The detection circuit unit supplies a detection signal indicating an input in the operation unit to the signal processing circuit unit. The signal processing circuit unit outputs a start signal to the starting circuit unit in response to reception of the detection signal, and drives each component, for example, starts the engine 180 by using the starter motor. Further, a driving force of the engine 180 is transmitted to the working unit (not illustrated), and the working unit is driven.

FIG. 3 is a state transition diagram of the control unit according to the embodiment. The control unit 160 enters the operation state based on the power from the battery 170, and has the normal mode and the power saving mode as the operation modes. The normal mode is a mode in which the engine 180 is drivable and other components in the outboard machine are also drivable. The power saving mode is a mode in which some of the functions of the control unit 160 are limited unlike the normal mode, the engine 180 is not drivable, some of other components in the outboard machine are also not drivable, and the power consumption amount of the battery 170 is suppressed to be smaller than a power consumption amount of the battery in the normal mode. In the power saving mode, the battery 170 is prevented from being down when the outboard machine 100 is not used for a relatively long period of time, and the user is not forced to remove the battery 170, such that usability of the outboard machine 100 is also improved.

The limitation of some of the functions of the control unit 160 in the power saving mode can be implemented by deactivating a component in the control unit 160 that is associated with the driving of the component of the outboard machine 100, for example, by suppressing the supply of a power supply voltage to the component in the control unit 160, limiting a bias current in the component, or the like. In an embodiment, a maximum current consumption amount of the control unit 160 is about 15 mA in the normal mode, and is about 170 μA in the power saving mode.

In addition, a stop state is a state in which all the functions of the control unit 160 are limited in a case where, for example, the power from the battery 170 is substantially absent or insufficient. The stop state is a state in which a system of the control unit 160 is down, and there is substantially no power consumption in the control unit 160 (the maximum current consumption amount is less than 10 μA). Note that, in relation to the stop state, the normal mode may be referred to as a started state or the like, and the power saving mode may also be referred to as a partially started state, a sleep state, or the like.

In an embodiment, the control unit 160 in the stop state is switched to the normal mode when a condition A11 is satisfied. The condition A11 includes a state in which the power supply switch is operated to the ON position. In response to the control unit 160 being switched to the normal mode, the detection circuit unit can detect an input operation of the user performed on the start switch. In a case where the start switch is operated by the user, the control unit 160 drives the engine 180.

When a condition A12 is satisfied, the control unit 160 in the normal mode is switched to the power saving mode. The condition A12 includes a state in which the operation to the operation unit has not been performed for a predetermined time. In response to the control unit 160 being switched to the power saving mode, the detection circuit unit cannot detect the input operation of the user performed on the start switch.

When a condition A13 is satisfied, the control unit 160 in the power saving mode shifts to the stop state. The condition A13 includes a state in which the power supply switch 130 is operated to the OFF position.

When a condition A14 is satisfied, the control unit 160 in the power saving mode is switched to the normal mode. An example of the condition A14 includes a state in which the emergency stop switch 140 has been operated. In response to the control unit 160 being switched to the normal mode, the detection circuit unit can detect an input operation of the user performed on the start switch. In a case where the start switch is operated by the user, the control unit 160 drives the engine 180.

When a condition A15 is satisfied, the control unit 160 in the normal mode is switched to the stop state. An example of the condition A15 includes a state in which the power supply switch 130 is operated to the OFF position.

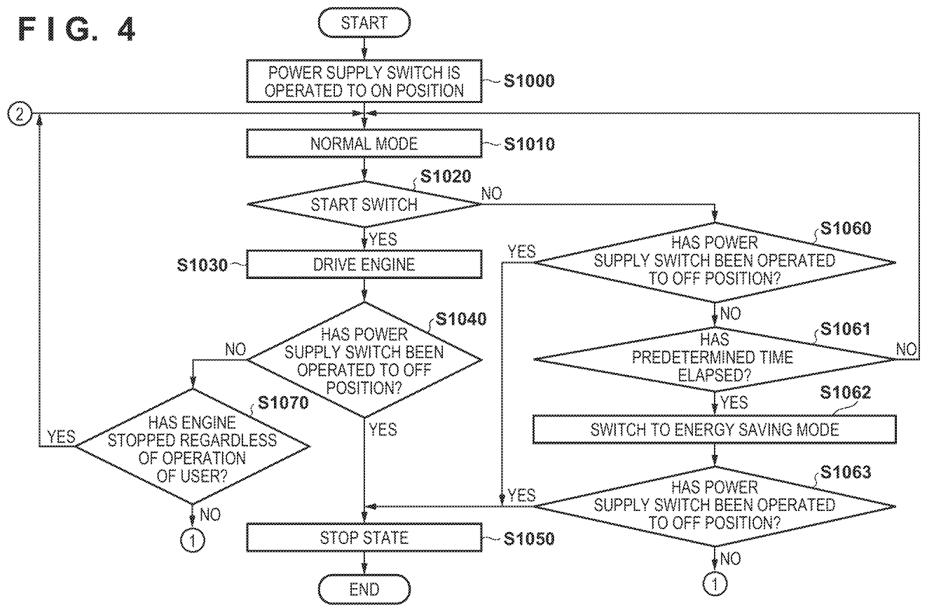

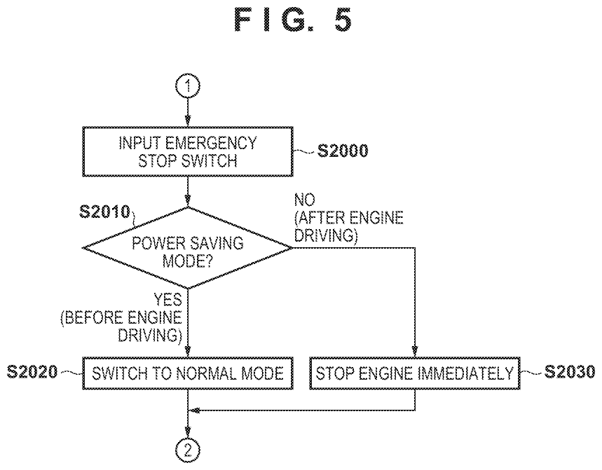

FIGS. 4 and 5 are flowcharts illustrating a control mode of the control unit based on an input operation of the user performed on the operation unit. When the user attempts to use the outboard machine 100, the control unit 160 is generally in the stop state. In step S1000 (hereinafter, simply indicated as “S1000”, and the same applies to other steps), the power supply switch 130 is operated to the ON position by the user, the processing proceeds to S1010, and the control unit 160 is switched to the normal mode in which the engine 180 is drivable.

In S1010, the control unit 160 can detect an input operation performed on the start switch, and the processing proceeds to S1020. In S1020, it is determined whether or not the start switch has been operated. In a case where the start switch has been operated, the processing proceeds to S1030, otherwise, the processing proceeds to S1060. In S1030, the engine 180 is driven by the starter motor, such that the working unit and the like can be driven, and work and the like are performed. S1060 will be described later.

In S1040, it is determined whether or not the power supply switch 130 has been operated to the OFF position. In a case where the power supply switch 130 has been operated to the OFF position, the processing proceeds to S1050, otherwise, the processing proceeds to S1070. In S1050, the engine 180 is stopped, the control unit 160 is switched to the stop state, and the processing ends. S1070 will be described later.

A case where the start switch has not been operated in S1020 will be described. The processing proceeds to S1060, where it is determined whether or not the power supply switch 130 has been operated to the OFF position. In a case where the power supply switch 130 has been operated to the OFF position, the processing proceeds to S1050, otherwise, the processing proceeds to S1061. In S1050, the engine 180 is stopped, the control unit 160 is switched to the stop state, and the processing ends.

An example in which the processing proceeds from S1020 to S1050 via S1060 described above includes a case where, since the engine 180 is drivable and other components in the outboard machine 100 are also drivable in the normal mode, the user does not drive the engine 180 (does not operate the start switch), drives the driven mechanism such as the steering mechanism or the shift changing mechanism, and then operates the power supply switch 130 to the OFF position in S1060. Alternatively, as will be described later, in a case where the power supply switch 130 is not operated to the OFF position and the engine 180 is stopped, the control unit 160 is switched to the normal mode. Therefore, although the engine 180 can be driven, the engine 180 is not driven, and the power supply switch 130 is operated to the OFF position in S1060 in some cases.

In a case where the power supply switch 130 is not operated to the OFF position in S1060, the processing proceeds to S1061, and it is determined whether or not a predetermined time has elapsed. In a case where the predetermined time has elapsed, the processing proceeds to S1062. Otherwise, the processing proceeds to S1010. The signal processing circuit unit of the control unit incorporates a counter (measurement unit) that measures an elapsed time from the reception of the detection signal from the power supply switch 130, and the control unit 160 can perform the above-described determination based on the measurement result.

In S1062, the control unit 160 is switched from the normal mode to the power saving mode. That is, in a case where the operation performed by the user is not performed for a predetermined time, the control unit 160 is switched to the power cutoff state (power saving mode) in which the power from the battery 170 is not substantially supplied to each component in order to suppress the battery from being down.

The processing proceeds to S1063, where it is determined whether or not the power supply switch 130 has been operated to the OFF position. In a case where the power supply switch 130 has been operated to the OFF position, the processing proceeds to S1050, otherwise, the processing proceeds to S2000. In a case where the power supply switch 130 has been operated to the OFF position in S1063, the engine 180 is stopped, the control unit 160 is switched to the stop state, and the processing ends.

In a case where the power supply switch 130 has not been operated to the OFF position in S1063, the processing proceeds to S2000 of FIG. 5. In S2000, an input operation is performed on the emergency stop switch 140, and the processing proceeds to S2010. In S2010, it is determined whether or not the control unit 160 is in the power saving mode. In a case where the control unit 160 is in the power saving mode, the processing proceeds to S2020. Otherwise, the processing proceeds to S2030. In a case where the control unit 160 is in the power saving mode, the control unit 160 is switched to the normal mode in S2030, and the processing proceeds to S1010 of FIG. 4. A case where the control unit 160 is not in the power saving mode will be described later.

An example in which the processing proceeds from S2000 to S2020 described above includes a case where the user has forgotten to operate the power supply switch 130 to the OFF position. In this case, although the power supply switch 130 is at the ON position, the user cannot operate the start switch when trying to operate the start switch to reuse the outboard machine 100 because the control unit 160 is in the power saving mode. In this case, the user can perform an input operation on the emergency stop switch 140 to perform switching from the power saving mode to the normal mode, and can operate the start switch. The user does not have to operate the power supply switch 130 to the OFF position and then operate the power supply switch 130 to the ON position again to return to the normal mode.

In addition, in the power saving mode, it is not possible to know whether the battery of the outboard machine 100 is down or the engine has a driving trouble, and when the engine is driven in the power saving mode by operating the power supply switch 130 to the OFF position and then operating the power supply switch 130 to the ON position, there is a possibility that the engine is suddenly started in a state in which a standby state is not confirmed. However, since switching from the power saving mode to the normal mode is made by performing the input operation on the emergency stop switch 140, the user can start the engine 180 after confirming the standby state (operation mode).

Referring back to FIG. 4, a case where the power supply switch 130 is not operated to the OFF position in S1040 will be described. The processing proceeds to S1070, and it is determined whether or not the engine 180 has stopped regardless of the input operation of the user, due to a failure, an overload on the working unit, a fuel shortage, or the like. In a case where the engine 180 has stopped regardless of the input operation of the user (in a case where the engine has automatically stopped), the processing proceeds to S1010, otherwise, the processing proceeds to S2000.

In a case where the processing proceeds to S1010 in S1070, the engine 180 is stopped regardless of the input operation of the user, and the power supply switch 130 remains operated to the ON position. Therefore, the control unit 160 remains in the normal mode, and the engine 180 is drivable. However, in a case where the engine 180 has stopped regardless of the input operation of the user, in order to solve the cause, the user proceeds the processing to S1060 without operating the start switch in S1020, the power supply switch 130 is operated to the OFF position, the processing proceeds to S1050, the control unit 160 is switched to the stop state, and the processing ends.

In S1070, in a case where the engine 180 has not stopped regardless of the input operation of the user (in a case where the engine has not been automatically stopped), the processing proceeds to S2000 of FIG. 5. In S2000, an input operation is performed on the emergency stop switch 140, and the processing proceeds to S2010. In S2010, it is determined whether or not the control unit 160 is in the power saving mode. In a case where the control unit 160 is in the power saving mode, the processing proceeds to S2020. Otherwise, the processing proceeds to S2030. In a case where the control unit 160 is in the power saving mode, the above-described processing is performed, and a description thereof will be omitted. In a case where the control unit 160 is not in the power saving mode, the processing proceeds to S2030, and the control unit 160 immediately stops the engine 180, and the processing proceeds to S1010 of FIG. 4.

In summary of the driving machine according to the embodiment, in a case where the user has forgotten to operate the power supply switch 130 to the OFF position, the control unit 160 is switched to the power saving mode. At the time of restarting the engine 180 of the outboard machine 100, since the power supply switch 130 is at the ON position in the power saving mode, the user operates the start switch to drive the engine 180. However, the start switch cannot be operated in the power saving mode. Therefore, the user performs the input operation on the emergency stop switch 140, such that the start switch can be operated, that is, switching from the power saving mode to the normal mode can be easily performed.

In addition, the user understands that the emergency stop switch 140 stops the engine 180. Therefore, the user understands that even when the user operates the emergency stop switch 140 in state in which the power supply switch 130 is at the ON position, the engine 180 is not driven, that is, a hull including the outboard machine 100 is not suddenly moved. Therefore, in a case of performing switching from the power saving mode to the normal mode, the user can operate the emergency stop switch 140 at ease.

Since the control unit 160 is switched from the power saving mode to the operation mode based on the input operation performed on the emergency stop switch 140, it is not necessary to newly provide a dedicated switch for switching the operation mode. In addition, the emergency stop switch 140 is disposed closer to the user operating the outboard machine 100 than the power supply switch 130 is or is disposed at a portion where the emergency stop switch 140 can be easily operated by the user due to the function of immediately stopping the engine 180. As a result, it is possible to easily perform switching from the power saving mode to the normal mode.

### Summary of Embodiment

The above-described embodiment discloses at least the following driving machine.

1. The driving machine of the above-described embodiment includes:
an engine (180);
a battery (170);
an operation unit including an emergency stop switch (140) that stops the engine (180); and
a control unit (160) having operation modes, the operation modes including a normal mode in which the engine (180) is drivable and a power saving mode in which the engine (180) is not drivable and a power consumption amount of the battery (170) is suppressed to be smaller than a power consumption amount of the battery in the normal mode,
in which the control unit (160) switches from the power saving mode to the normal mode based on an input of the emergency stop switch (140) when the operation mode is the power saving mode.

According to this embodiment, when performing switching from the power saving mode to the normal mode, it is not necessary to switch the power supply switch from the OFF position to the ON position. Further, the user recognizes that the emergency stop switch has a function of stopping the engine or the working unit, and the engine or the working unit is not driven even when the user performs an input operation on the emergency stop switch. Therefore, the user can operate the emergency stop switch at ease.

2. In the above-described embodiment,
the operation unit includes a power supply switch (130) and a start switch that is provided integrally with the power supply switch (130) and drives the engine (180).

According to this embodiment, the operation of driving the engine is facilitated.

3. In the above-described embodiment,
the driving machine further includes a display unit (150) that displays that the emergency stop switch (140) has an emergency stop function and an operation mode switching function.

According to this embodiment, the user can recognize that returning from the power saving mode can be made by using the emergency stop switch.

4. In the above-described embodiment,
the driving machine is an outboard machine (100).

According to this embodiment, in the outboard machine, the emergency stop switch may be disposed closer to the user than the power supply switch is, such that returning from the power saving mode to the normal mode can be easily made.

The invention is not limited to the foregoing embodiments, and various variations/changes are possible within the spirit of the invention.

What is claimed is:

1. A driving machine comprising:
an engine;
a battery;
an operation unit including an emergency stop switch that stops the engine; and
a control unit having operation modes, the operation modes including a normal mode in which the engine is drivable and a power saving mode in which the engine is not drivable and a power consumption amount of the battery is suppressed to be smaller than a power consumption amount of the battery in the normal mode,
wherein the control unit switches from the power saving mode to the normal mode based on an input of the emergency stop switch when the operation mode is the power saving mode.

2. The driving machine according to claim 1, wherein the operation unit includes a power supply switch and a start switch that is provided integrally with the power supply switch and drives the engine.

3. The driving machine according to claim 1, further comprising a display unit that displays that the emergency stop switch has an emergency stop function and an operation mode switching function.

4. The driving machine according to claim 1, wherein the driving machine is an outboard machine.
